(19) United States
(12) Patent Application Publication
(10) Pub. No.: US 2023/0196851 A1
(43) Pub. Date: Jun. 22, 2023

(54) AGRICULTURAL SYSTEM AND METHOD FOR MONITORING WEAR RATES OF AGRICULTURAL IMPLEMENTS

(71) Applicant: CNH Industrial Canada, Ltd., Saskatoon (CA)

(72) Inventors: Sai Raghavendra Prasad Poosa, Darien, IL (US); Brittany Schroeder, Lowell, IN (US); James W. Henry, Saskatoon (CA)

(21) Appl. No.: 17/559,063

(22) Filed: Dec. 22, 2021

(51) Int. Cl. G07C 5/08; A01B 76/00

(52) U.S. Cl. CPC G07C 5/0808; A01B 76/00; G07C 5/0816

(57) ABSTRACT

A system for monitoring the wear rates of agricultural implements may include an agricultural implement having ground-engaging tools configured to work a field area, at least one wear sensor configured to generate data indicative of wear of one or more of the ground-engaging tools, and a computing system communicatively coupled to the at least one wear sensor. The computing system may determine a first wear rate of the one or more of the ground-engaging tools based at least in part on the data indicative of the wear of the one or more of the ground-engaging tools and to compare the first wear rate to a threshold wear rate. Additionally, the computing system may perform a control action when a differential between the first wear rate and the threshold wear rate exceeds a wear rate differential threshold.

### FIELD OF THE INVENTION

The present disclosure relates generally to agricultural implements and, more particularly to systems and methods for monitoring wear rates of ground-engaging tools of agricultural implements.

### BACKGROUND OF THE INVENTION

A wide range of agricultural implements have been developed and are presently in use for tilling, cultivating, harvesting, and so forth. Tillage implements, for example, are commonly towed behind tractors and may cover wide swaths of ground that include various types of residue. Such residue may include materials left in the field after the crop has been harvested (e.g., stalks and stubble, leaves, and seed pods). Good management of field residue can increase efficiency of irrigation and control of erosion in the field.

Tillage implements typically include ground-engaging tools, such as shanks and shank attachment members (e.g., tillage points, chisels, etc.), disk blades, rolling or “crumbler” basket assemblies, closing disks, and/or the like configured to condition the soil for improved moisture distribution while reducing soil compaction from sources such as machine traffic, grazing cattle, and standing water. The ground-engaging tools are typically replaceable and come in a wide variety to accommodate different field conditions and the desired results of the tilling operation. Unfortunately, monitoring the wear on various ground-engaging tools is time consuming and relies heavily on the operator to determine when it is time to replace each ground-engaging tool. If an operator is less experienced, it may be more difficult for the operator to determine the correct time to replace the ground-engaging tools, which can often lead to the operator replacing too early, which is cost-ineffective, or too late, which may damage reusable parts and/or negatively affect performance. Further, it may be difficult for an inexperienced operator to recognize when ground-engaging tools are wearing quicker than expected.

Accordingly, an improved agricultural system and method for automatically monitoring wear rates of ground-engaging tools of agricultural implements would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to a system for monitoring the wear rates of agricultural implements. The system may include an agricultural implement having ground-engaging tools configured to work a field area, at least one wear sensor configured to generate data indicative of wear of one or more of the ground-engaging tools, and a computing system communicatively coupled to the at least one wear sensor. The computing system may be configured to receive the data indicative of the wear of the one or more of the ground-engaging tools. The computing system may further be configured to determine a first wear rate of the one or more of the ground-engaging tools based at least in part on the data indicative of the wear of the one or more of the ground-engaging tools and to compare the first wear rate to a threshold wear rate. Additionally, the computing system may be configured to perform a control action when a differential between the first wear rate and the threshold wear rate exceeds a wear rate differential threshold.

In another aspect, the present subject matter is directed to a method for monitoring the wear rate of an agricultural implement having ground-engaging tools configured to work a field area. The method may include receiving, with a computing system, data indicative of wear of one or more of the ground-engaging tools. The method may further include determining, with the computing system, a wear rate of the one or more of the ground-engaging tools based at least in part on the data indicative of the wear of the one or more of the ground-engaging tools. Moreover, the method may include comparing, with the computing system, the wear rate of the one or more of the ground-engaging tools to a threshold wear rate. Additionally, the method may include performing, with the computing system, a control action when a differential between the wear rate of the one or more of the ground-engaging tools and the threshold wear rate exceeds a wear rate differential threshold.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of one embodiment of an agricultural implement coupled to a work vehicle in accordance with aspects of the present subject matter;

FIG. 2 illustrates another perspective view of the agricultural implement shown in FIG. 1 in accordance with aspects of the present subject matter, particularly illustrating various ground-engaging tools and/or assemblies of the implement;

FIG. 3 illustrates a schematic view of a system for monitoring wear rates of ground-engaging tools of agricultural implements in accordance with aspects of the present subject matter; and

FIG. 4 illustrates a flow diagram of one embodiment of a method for monitoring wear rates of ground-engaging tools of agricultural implements in accordance with aspects of the present subject matter.

Repeat use of reference characters in the present specification and drawings is intended to represent the same or analogous features or elements of the present technology.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to systems and methods for monitoring wear rates of agricultural implements, particularly for monitoring wear rates of ground-engaging tools or attachments of agricultural implements. Specifically, in several embodiments, a computing system may be configured to receive data indicative of wear of one or more ground-engaging tools of an agricultural implement. The data indicative of the wear may be generated, for example, by one or more wear sensors associated with (e.g., positioned on) the agricultural implement and/or one or more wear sensors remote from the agricultural implement. The computing system may further be configured to determine a wear rate of the ground-engaging tool(s) based at least in part on the data indicative of the wear of the ground-engaging tool(s) and to compare the wear rate to a threshold wear rate. In one embodiment, the threshold wear rate is a predetermined wear rate for the ground-engaging tool(s). In another embodiment, the threshold wear rate is the wear rate of ground-engaging tools of another agricultural implement (e.g., another agricultural implement with a substantially similar configuration). When a differential between the first wear rate and the threshold wear rate exceeds a wear rate differential threshold, the computing system may then perform a control action. For instance, the computing system may adjust an operating parameter of the agricultural implement to slow down the wear and/or may control an operation of a user interface to indicate that the ground-engaging tool(s) are wearing faster than the predetermined expected wear rate. As such, by using the systems and methods disclosed herein, evaluation of the wear rate of ground-engaging tools is performed automatically, which reduces costs and increases efficiency.

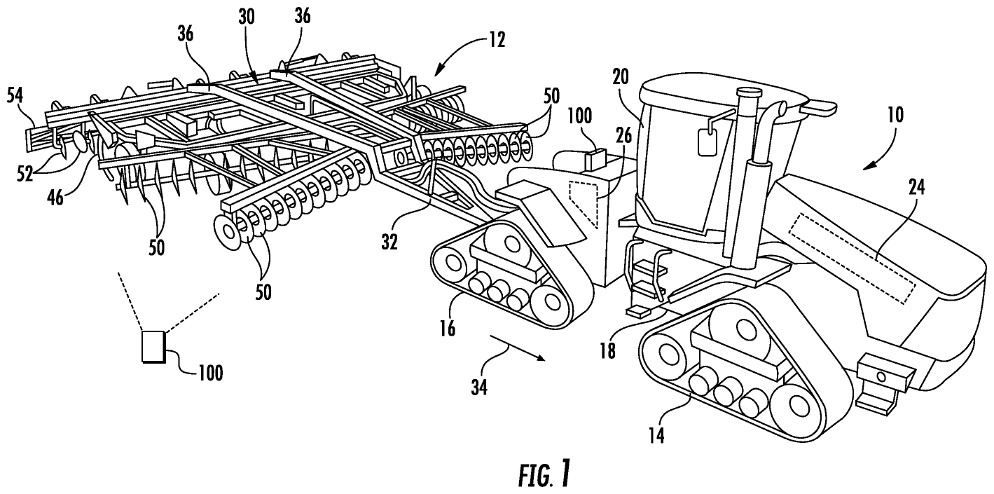

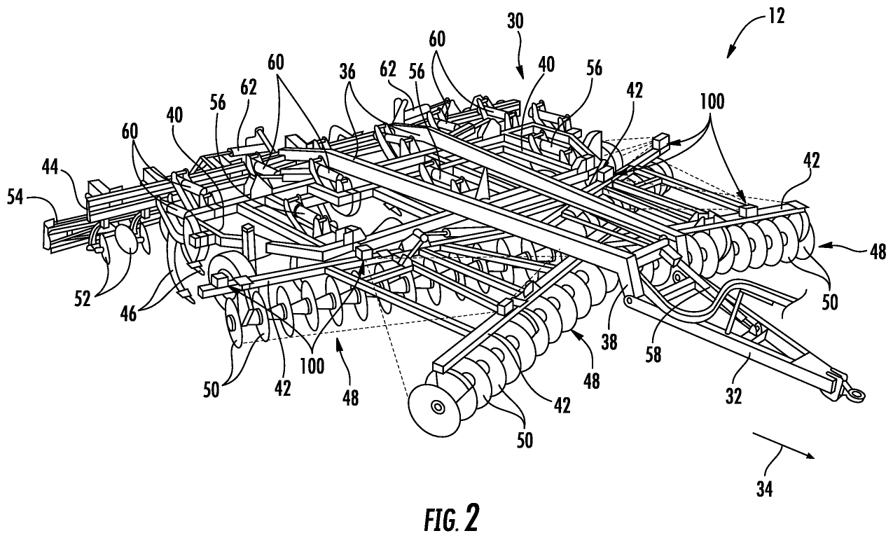

Referring now to drawings, FIGS. 1 and 2 illustrate perspective views of one embodiment of a work vehicle 10 and an associated agricultural implement 12 in accordance with aspects of the present subject matter. Specifically, FIG. 1 illustrates a perspective view of the work vehicle 10 towing the implement 12 (e.g., across a field). Additionally. FIG. 2 illustrates a perspective view of the implement 12 shown in FIG. 1. As shown in the illustrated embodiment, the work vehicle 10 is configured as an agricultural tractor. However, in other embodiments, the work vehicle 10 may be configured as any other suitable agricultural vehicle.

As particularly shown in FIG. 1, the work vehicle 10 includes a pair of front track assemblies 14, a pair or rear track assemblies 16 and a frame or chassis 18 coupled to and supported by the track assemblies 14, 16. An operator's cab 20 may be supported by a portion of the chassis 18 and may house various input devices for permitting an operator to control the operation of one or more components of the work vehicle 10 and/or one or more components of the implement 12. Additionally, as is generally understood, the work vehicle 10 may include an engine 24 and a transmission 26 mounted on the chassis 18. The transmission 26 may be operably coupled to the engine 24 and may provide variably adjusted gear ratios for transferring engine power to the track assemblies 14, 16 via a drive axle assembly (not shown) (or via axles if multiple drive axles are employed).

Moreover, as shown in FIGS. 1 and 2, the implement 12 may generally include a carriage frame assembly 30 configured to be towed by the work vehicle via a pull hitch or tow bar 32 in a travel direction of the vehicle (e.g., as indicated by arrow 34). As is generally understood, the carriage frame assembly 30 may be configured to support a plurality of ground-engaging tools, such as a plurality of shanks, disk blades, leveling blades, basket assemblies, and/or the like. In several embodiments, the various ground-engaging tools may be configured to perform a tillage operation across the field along which the implement 12 is being towed.

As particularly shown in FIG. 2, the carriage frame assembly 30 may include aft extending carrier frame members 36 coupled to the tow bar 32. In addition, reinforcing gusset plates 38 may be used to strengthen the connection between the tow bar 32 and the carrier frame members 36. In several embodiments, the carriage frame assembly 30 may generally function to support a central frame 40, a forward frame 42 positioned forward of the central frame 40 in the direction of travel 34 of the work vehicle 10, and an aft frame 44 positioned aft of the central frame 40 in the direction of travel 34 of the work vehicle 10. As shown in FIG. 2, in one embodiment, the central frame 40 may correspond to a shank frame configured to support a plurality of ground-engaging shanks 46. In such an embodiment, the shanks 46 may be configured to till the soil as the implement 12 is towed across the field. However, in other embodiments, the central frame 40 may be configured to support any other suitable ground-engaging tools.

Additionally, as shown in FIG. 2, in one embodiment, the forward frame 42 may correspond to a disk frame configured to support various gangs or sets 48 of disk blades 50. In such an embodiment, each disk blade 50 may, for example, include both a concave side (not shown) and a convex side (not shown). In addition, the various gangs 48 of disk blades 50 may be oriented at an angle relative to the travel direction 34 of the work vehicle 10 to promote more effective tilling of the soil. However, in other embodiments, the forward frame 42 may be configured to support any other suitable ground-engaging tools.

Moreover, similar to the central and forward frames 40, 42, the aft frame 44 may also be configured to support a plurality of ground-engaging tools. For instance, in the illustrated embodiment, the aft frame is configured to support a plurality of leveling blades 52 and rolling (or crumbler) basket assemblies 54. However, in other embodiments, any other suitable ground-engaging tools may be coupled to and supported by the aft frame 44, such as a plurality closing disks or harrow tines.

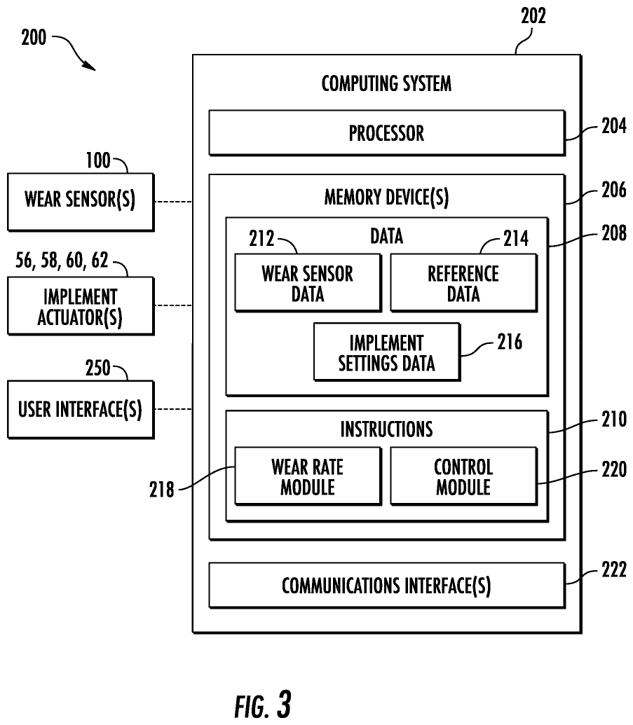

In addition, the implement 12 may also include any number of suitable actuators (e.g., hydraulic cylinders) for adjusting the relative positioning, engagement angle, penetration depth, and/or down force associated with the various ground-engaging tools 46, 50, 52, 54. For instance, the implement 12 may include one or more shank actuators 56 coupled to the central frame 40 for raising or lowering the central frame 40 relative to the ground, thereby allowing the penetration depth of the shanks 46 to be adjusted. Similarly, the implement 12 may include one or more disk actuators 58 coupled to the disk forward frame 42 to adjust the penetration depth of the disk blades 50. Moreover, the implement 12 may include one or more aft frame actuators 60 coupled to the aft frame 44 to allow the aft frame 44 to be moved relative to the central frame 40, thereby allowing the relevant operating parameters of the ground-engaging tools 52, 54 supported by the aft frame 44 (e.g., the down pressure and/or the penetration depth) to be adjusted. Further, the implement 12 may include one or more basket actuators 62 coupled to the baskets 54 to adjust the down pressure of the baskets 54. Additionally, the implement 12 may include one or more disk angle actuators 64 (FIG. 3) coupled to respective disk gangs 48 to allow the disk gangs 48 to be pivoted relative to the central frame 40, thereby allowing the engagement angle of the disk gangs 48 to be adjusted.

Additionally, in accordance with aspects of the present subject matter, one or more wear sensors 100 may be provided in association with the agricultural implement 12 and configured to generate data indicative of wear of one or more of the ground-engaging tools 46, 50, 52, 54 of the agricultural implement 12. For instance, as shown in FIG. 1, the wear sensor(s) 100 may be associated with or positioned on the work vehicle 10 and oriented to have a field of detection directed rearward of the work vehicle 10 toward the ground-engaging tool(s) 46, 50, 52, 54 of the agricultural implement 12. Alternatively, or additionally, as shown in FIG. 2, the wear sensor(s) 100 may be positioned at one or more locations on the agricultural implement 12 and directed toward the ground-engaging tool(s) 46, 50, 52, 54. Further, as shown in FIG. 1, the wear sensor(s) 100 may alternatively, or additionally, be remote from the work vehicle 10 and/or the agricultural implement 12. For instance, the wear sensor(s) 100 may be mobile (e.g., part of a handheld mobile device) and/or may be otherwise positionable in the field and/or at a maintenance location.

The wear sensor(s) 100 may correspond to any suitable device(s) configured to capture images or other vision-based or image-like data of the ground-engaging tools 46, 50, 52, 54 that allow the wear of the ground-engaging tools 46, 50, 52, 54 to be detected. For instance, in several embodiments, the wear sensor(s) may correspond to any suitable camera(s), such as single-spectrum camera or a multi-spectrum camera configured to capture images, for example, in the visible light range and/or infrared spectral range. Additionally, in a particular embodiment, the camera(s) may correspond to a single lens camera configured to capture two-dimensional images or a stereo camera(s) having two or more lenses with a separate image sensor for each lens to allow the camera(s) to capture stereographic or three-dimensional images. Alternatively, the wear sensor(s) 100 may correspond to any other suitable image capture device(s) and/or other vision sensor(s) capable of capturing “images” or other image-like data of the ground-engaging tools 46, 50, 52, 54 and/or implement 12. For example, the wear sensor(s) 100 may correspond to or include radio detection and ranging (RADAR) sensors and/or light detection and ranging (LIDAR) sensors.

As will be described in greater detail below, the data generated by the wear sensor(s) 100 may be used to determine the wear rate of the ground-engaging tools 46, 50, 52, 54 of the implement 12. In one embodiment, the wear rate of the ground-engaging tools 46, 50, 52, 54 of the implement 12 may be compared to an expected, threshold wear rate for the respective ground-engaging tool 46, 50, 52, 54. If the wear rate of the ground-engaging tools 46, 50, 52, 54 of the implement 12 is significantly faster or higher than the threshold wear rate, an operator of the implement 12 may be notified and/or one or more settings of the work vehicle 10 and/or the implement 12 may be adjusted to reduce the subsequent wear rate (e.g., slowing down the work vehicle 10, reducing the penetration depth of the ground-engaging tools 46, 50, 52, 54, and/or the like).

In some embodiments, the wear rate of the ground-engaging tools 46, 50, 52, 54 of the agricultural implement 12 may be compared to a wear rate of ground-engaging tools of another agricultural implement (not shown). For instance, the work vehicle 10 and the implement 12 may be a first work vehicle 10 and a first implement 12 configured to work a first field area of a field and another work vehicle/implement pair, such as another or second one of the work vehicle 10 and another or second one of the implement 12, may be configured to work a second field area of the field, where the first and second areas may be the same, at least partially the same, or may be different. In one embodiment, the second work vehicle and/or implement is associated with wear sensors 100 configured to generate wear data indicative of the wear of the ground-engaging tools 46, 50, 52, 54 of the second implement. In some embodiments, the wear sensor(s) 100 are remote to the first work vehicle 10, the first implement 12, the second work vehicle, and the second implement such that the same wear sensor(s) 100 may be used to generate data indicative of the wear of the ground-engaging tools of both the first implement and the second implement. It should be appreciated that the second work vehicle and/or the second agricultural implement does not have to have the same configuration as the first work vehicle 10 and the first agricultural implement 12. For instance, the second implement may not be configured as a towed implement and/or may have only one or a few of the same or similar ground-engaging tools 46, 50, 52, 54 as the first implement 12. However, for the sake of brevity, the first and second work vehicle/implement pairs 10, 12 will be referred to with the same reference numbers.

If the first and second implements 12 have the same operational settings (e.g., ground speed of the respective work vehicle 10, penetration depth of the ground-engaging tool(s), etc.) and field parameters (e.g., moisture content, soil composition, preparation, etc. of the field), but the ground-engaging tool(s) 46, 50, 52, 54 of the first implement 12 are wearing faster than the ground-engaging tool(s) 46, 50, 52, 54 of the second implement, then there may be something wrong with the calibration and/or assembly of the first implement 12. Similarly, if the first and second implements 12 have different operational settings (e.g., ground speed of the respective work vehicle 10, penetration depth of the ground-engaging tool(s), etc.) and the same field parameters (e.g., moisture content, soil composition, preparation, etc. of the field), but the ground-engaging tool(s) 46, 50, 52, 54 of the first implement 12 are wearing faster than the ground-engaging tool(s) 46, 50, 52, 54 of the second implement, then the operational settings of the second implement may be preferred over the first implement 12. After determining that the wear rate(s) of the ground-engaging tools 46, 50, 52, 54 of the first implement 12 is higher than the ground-engaging tools 46, 50, 52, 54 of the second implement, then an operator of at least the first implement 12 may be notified and/or one or more settings of the first work vehicle 10 and/or the first implement 12 may be adjusted to reduce the subsequent wear rate of the first implement 12 (e.g., slowing down the first work vehicle 10, reducing the penetration depth of the ground-engaging tools 46, 50, 52, 54 of the first implement 12, and/or the like).

It should be appreciated that the configuration of the work vehicle(s) 10 described above and shown in FIG. 1 is provided only to place the present subject matter in an exemplary field of use. Thus, it should be appreciated that the present subject matter may be readily adaptable to any manner of work vehicle configuration. For example, in an alternative embodiment, a separate frame or chassis may be provided to which the engine, transmission, and drive axle assembly are coupled, a configuration common in smaller tractors. Still other configurations may use an articulated chassis to steer the work vehicle(s) 10, or rely on tires/wheels in lieu of the track assemblies 14, 16.

It should also be appreciated that the configuration of the implement(s) 12 described above and shown in FIGS. 1 and 2 is only provided for exemplary purposes. Thus, it should be appreciated that the present subject matter may be readily adaptable to any manner of implement configuration. For example, as indicated above, each frame section of the implement(s) 12 may be configured to support any suitable type of ground-engaging tools, such as by installing closing disks or harrow tines on the aft frame 44 of the implement(s) 12.

Referring now to FIG. 3, a schematic view of one embodiment of a system 200 for monitoring wear rates of ground-engaging tools of agricultural implement is illustrated in accordance with aspects of the present subject matter. In general, the system 200 will be described with reference to the vehicle(s) 10 and the implement(s) 12 described above with reference to FIGS. 1 and 2. However, it should be appreciated by those of ordinary skill in the art that the disclosed system 200 may generally be utilized with agricultural machines having any other suitable machine configuration. Additionally, it should be appreciated that, for purposes of illustration, communicative links or electrical couplings of the system 200 shown in FIG. 3 are indicated by dashed lines.

As shown in FIG. 3, the system 200 may include a computing system 202 and various other components configured to be communicatively coupled to and/or controlled by the computing system 202, such as one or more wear sensors (e.g., wear sensor(s) 100), various actuators of the implement(s) 12 (e.g., implement actuator(s) 56, 58, 60, 62), and/or one or more user interfaces (e.g., user interface(s) 250). The user interface 250 described herein may include, without limitation, any combination of input and/or output devices that allow an operator to provide operator inputs to the computing system 202 and/or that allow the computing system 202 to provide feedback to the operator, such as a keyboard, keypad, pointing device, buttons, knobs, touch sensitive screen, mobile device, audio input device, audio output device, and/or the like.

In general, the computing system 202 may correspond to any suitable processor-based device(s), such as a computing device or any combination of computing devices. Thus, as shown in FIG. 3, the computing system 202 may generally include one or more processor(s) 204 and associated memory devices 206 configured to perform a variety of computer-implemented functions (e.g., performing the methods, steps, algorithms, calculations and the like disclosed herein). As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory 206 may generally comprise memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory 206 may generally be configured to store information accessible to the processor(s) 204 including data 208 that can be retrieved, manipulated, created and/or stored by the processor(s) 204 and instructions 210 that can be executed by the processor(s) 204.

It should be appreciated that the computing system 202 may correspond to an existing controller for the vehicle(s) 10 or the implement(s) 12 or may correspond to a separate processing device. For instance, in one embodiment, the computing system 202 may form all or part of a separate plug-in module that may be installed in operative association with the vehicle(s) 10 or the implement(s) 12 to allow for the disclosed system and method to be implemented without requiring additional software to be uploaded onto existing control devices of the vehicle(s) 10 or the implement(s) 12.

In several embodiments, the data 208 may be stored in one or more databases. For example, the memory 206 may include a wear sensor database 212 for storing data generated by the wear sensor(s) 100. For example, the wear sensor(s) 100 may be configured to periodically and/or as-demanded capture vision-based data associated with the wear of the ground-engaging tools 46, 50, 52, 54 of the implement(s) 12, and, in some embodiments, vision-based data associated with the wear of the ground-engaging tools of another implement configured to work the field. For instance, the wear sensor(s) 100 may be configured to capture the wear data when the ground-engaging tool(s) 46, 50, 52, 54 are raised (e.g., at headland turns, transportation between fields, and/or the like), at predetermined working distance or time intervals (e.g., after every 10 acres, after every 8 working hours, and/or the like), when an operator requests, and/or at any other suitable time. In such an embodiment, the data transmitted to the computing system 202 from the wear sensor(s) 100 may be stored within the wear sensor database 212 for subsequent processing and/or analysis. It should be appreciated that, as used herein, the terms image data or image-like data may include any suitable type of data received from the wear sensor(s) 100 that allows for the wear of the ground-engaging tools 46, 50, 52, 54 of the implement(s) 12 to be determined, such as photographs or other images, RADAR data, LIDAR data, and/or other image-related data (e.g., scan data and/or the like).

Further, as shown in FIG. 3, the memory 206 may include a reference database 214. In some embodiments, the reference database 214 may be configured to store information related to one or more reference wear conditions for the ground-engaging tool(s) 46, 50, 52, 54 of the implement(s) 12 that may be used to determine the wear of the ground-engaging tool(s) 46, 50, 52, 54 of the implement(s) 12. For instance, the reference wear condition(s) for the ground-engaging tool(s) 46, 50, 52, 54 of the implement(s) 12 may include one or more reference images or 3D models that illustrate varying degrees of wear of the ground-engaging tool(s) 46, 50, 52, 54. For example, each reference image or model may represent a different percentage of wear of one of the ground-engaging tools 46, 50, 52, 54 (e.g., unused or 0% wear, 20% wear, 40% wear, 60% wear, 80% wear, 100% wear, and/or the like). In one embodiment, the reference image(s) or model(s) may include a reference image or model of the ground-engaging tool(s) 46, 50, 52, 54 in an unused state. As will be described in greater detail below, the wear data 212 may be compared to the reference images or models to determine the wear of the ground-engaging tool(s) 46, 50, 52, 54. In one embodiment, the reference database 214 may additionally, or alternatively, include one or more expected or threshold wear rates of the ground-engaging tool(s) 46, 50, 52, 54 of the implement(s) 12 and/or one or more wear rate differential thresholds that may be used to determine whether the wear rate of the ground-engaging tool(s) 46, 50, 52, 54 of the implement(s) 12 is higher than expected.

Additionally, the memory 206 may include an implement settings database 216 which may store the current operating conditions or settings of the implement(s) 12. For instance, the implement settings database 216 may include the ground speed of the work vehicle(s) 10 (and thus the ground speed of the implement(s) 12), the penetration depth of the ground-engaging tool(s) 46, 50, 52, 54 of the implement(s) 12, and/or the like.

In several embodiments, the instructions 210 stored within the memory 206 of the computing system 202 may be executed by the processor(s) 204 to implement a wear rate module 218. The wear rate module 218 may generally be configured to determine the wear rate of the ground-engaging tool(s) 46, 50, 52, 54 of the implement(s) 12. For instance, in one embodiment, the computing system 202 may be configured to analyze the wear sensor data 212 received from the wear sensor(s) 100 using one or more image processing techniques to automatically identify the ground-engaging tool(s) 46, 50, 52, 54. For example, the computing system 202 may identify a shape or outer profile of the ground-engaging tool(s) 46, 50, 52, 54. Thereafter, in one embodiment, the computing system 202 may compare the profile of the ground-engaging tool(s) 46, 50, 52, 54 to the reference image(s) or model(s) indicative of a particular percentage(s) of wear of the ground-engaging tool(s) 46, 50, 52, 54 stored in the reference database 214 to determine the wear of the ground-engaging tool(s) 46, 50, 52, 54. In one embodiment, the computing system 202 may then divide the percentage of wear of the ground-engaging tool(s) 46, 50, 52, 54 over the working time or distance the ground-engaging tool(s) 46, 50, 52, 54 has been used to determine the wear rate of the ground-engaging tool(s) 46, 50, 52, 54. In some embodiments, the computing system 202 may instead, or additionally, determine a slope of a trendline of the wear of the ground-engaging tool(s) 46, 50, 52, 54 over a plurality of working times or distances to determine the wear rate of the ground-engaging tool(s) 46, 50, 52, 54. The wear rate of the ground-engaging tool(s) 46, 50, 52, 54 of the implement(s) 12 may, in some embodiments, subsequently be stored in the wear sensor database 212 and/or the reference database 214.

In some embodiments, the instructions 210 stored within the memory 206 of the computing system 202 may be executed by the processor(s) 204 to implement a control module 220. The control module 220 may generally be configured to perform a control action based on the wear rate of the ground-engaging tool(s) 46, 50, 52, 54. For instance, in one embodiment, the control action may include the computing system 202 controlling an operation of the user interface(s) 250 to notify an operator of the current wear rate of the ground-engaging tool(s) 46, 50, 52, 54.

In some embodiments, the computing system 202 may first determine if the wear rate of the ground-engaging tool(s) 46, 50, 52, 54 is severe enough to require a control action. For instance, the computing system 202 may compare the wear rate of the ground-engaging tool(s) 46, 50, 52, 54 to a threshold wear rate. For example, the computing system 202 may determine a differential between the wear rate of the ground-engaging tool(s) 46, 50, 52, 54 and the threshold wear rate. The threshold wear rate may either be the predetermined threshold wear rate for the ground-engaging tool(s) 46, 50, 52, 54 from the reference database 214 or the wear rate of the ground engaging tool(s) of the other implement. If the differential between the wear rate of the ground-engaging tool(s) 46, 50, 52, 54 and the threshold wear rate exceeds a wear rate differential threshold, then a control action is to be performed.

For instance, if the differential between the wear rate of the ground-engaging tool(s) 46, 50, 52, 54 and the predetermined threshold wear rate exceeds the wear rate differential threshold, the control action may include the computing system 202 controlling an operation of the user interface(s) 250 to notify an operator that the ground-engaging tool(s) 46, 50, 52, 54 are wearing faster than the predetermined expected wear rate. The control action may additionally, or alternatively, include the computing system 202 automatically controlling an operation of the agricultural implement 12 (e.g., of the implement actuator(s) 56, 58, 60, 62) to reduce at least one of a ground speed of the agricultural implement 12 or a penetration depth of the ground-engaging tools ground-engaging tool(s) 46, 50, 52, 54. If the differential between the wear rate of the ground-engaging tool(s) 46, 50, 52, 54 and the wear rate of the ground engaging tool(s) of the other implement exceeds the wear rate differential threshold, the control action may include the computing system 202 controlling an operation of the user interface(s) 250 to notify an operator that the ground-engaging tool(s) 46, 50, 52, 54 are wearing faster than the ground-engaging tool(s) 46, 50, 52, 54 of the other implement. The control action may additionally, or alternatively, include automatically controlling an operation of the agricultural implement 12 (e.g., of the implement actuator(s) 56, 58, 60, 62) to adjust at least one implement setting (e.g., speed, penetration depth, and/or the like) of the agricultural implement 12 to match at least one implement setting (e.g., speed, penetration depth, and/or the like) of the other agricultural implement (e.g., to reduce at least one of a ground speed of the agricultural implement 12 or a penetration depth of the ground-engaging tools ground-engaging tool(s) 46, 50, 52, 54).

Additionally, as shown in FIG. 3, the computing system 202 may also include one or more communications interfaces 222 to provide a means for the computing system 202 to communicate with any of the various other system components described herein. For instance, one or more communicative links or interfaces (e.g., one or more data buses) may be provided between the communications interface(s) 222 and the wear sensor(s) 100 to allow data transmitted from the sensor(s) 100 to be received by the computing system 202. Similarly, one or more communicative links or interfaces (e.g., one or more data buses) may be provided between the communications interface 222 and the implement actuator(s) 56, 58, 60, 62 for the computing system 202 to control an operation of the implement actuator(s) 56, 58, 60, 62. Additionally, one or more communicative links or interfaces (e.g., one or more data buses) may be provided between the communications interface 222 and the user interface(s) 250 to allow operator inputs to be received by the computing system 202 and to allow the computing system 202 to control the operation of one or more components of the user interface(s) 250, for example, to provide one or more indicators of the wear of the ground-engaging tool(s) 46, 50, 52, 54 to an operator of the implement 12.

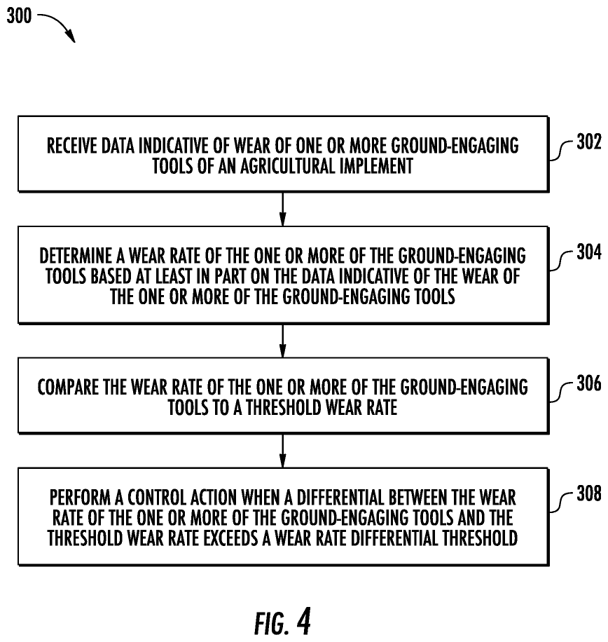

Referring now to FIG. 4, a flow diagram of one embodiment of a method 300 for monitoring wear rates of ground-engaging tools of agricultural implement is illustrated in accordance with aspects of the present subject matter. In general, the method 300 will be described herein with reference to the work vehicle 10 and the implement 12 shown in FIGS. 1 and 2, as well as the various system components shown in FIG. 3. However, it should be appreciated that the disclosed method 300 may be implemented with work vehicles and/or implements having any other suitable configurations and/or within systems having any other suitable system configuration. In addition, although FIG. 4 depicts steps performed in a particular order for purposes of illustration and discussion, the methods discussed herein are not limited to any particular order or arrangement. One skilled in the art, using the disclosures provided herein, will appreciate that various steps of the method disclosed herein can be omitted, rearranged, combined, and/or adapted in various ways without deviating from the scope of the present disclosure.

As shown in FIG. 4, at (302), the method 300 may include receiving data indicative of wear of one or more ground-engaging tools of an agricultural implement. For instance, as indicated above, the computing system 202 may receive wear data indicative of wear of the ground-engaging tool(s) 46, 50, 52, 54 of the implement 12, the wear data being generated by the wear sensor(s) 100.

Further, at (304), the method 300 may include determining a wear rate of the one or more of the ground-engaging tools based at least in part on the data indicative of the wear of the one or more of the ground-engaging tools. For example, as discussed above, the computing system 202 may determine a wear rate of the ground-engaging tool(s) 46, 50, 52, 54 based at least in part on the data indicative of the wear of the ground-engaging tool(s) 46, 50, 52, 54.

Moreover, at (306), the method 300 may include comparing the wear rate of the one or more of the ground-engaging tools to a threshold wear rate. For instance, as discussed above, the computing system 202 may compare the wear rate of the ground-engaging tool(s) 46, 50, 52, 54 to a threshold wear rate, such as the predetermined threshold wear rate or the wear rate of ground-engaging tools of another implement.

Additionally, at (308), the method 300 may include performing a control action w % ben the differential between the wear rate of the one or more of the ground-engaging tools and the threshold wear rate exceeds a wear rate differential threshold. For example, as described above, the computing system 202 may perform a control action when the differential between the wear rate of the ground-engaging tool(s) 46, 50, 52, 54 and the threshold wear rate exceeds a wear rate differential threshold.

It is to be understood that the steps of the method 30) are performed by the computing system 200 upon loading and executing software code or instructions which are tangibly stored on a tangible computer readable medium, such as on a magnetic medium, e.g., a computer hard drive, an optical medium, e.g., an optical disk, solid-state memory, e.g., flash memory, or other storage media known in the art. Thus, any of the functionality performed by the computing system 200 described herein, such as the method 300, is implemented in software code or instructions which are tangibly stored on a tangible computer readable medium. The computing system 200 loads the software code or instructions via a direct interface with the computer readable medium or via a wired and/or wireless network. Upon loading and executing such software code or instructions by the computing system 200, the computing system 200 may perform any of the functionality of the computing system 200 described herein, including any steps of the method 300 described herein.

The term “software code” or “code” used herein refers to any instructions or set of instructions that influence the operation of a computer or computing system. They may exist in a computer-executable form, such as machine code, which is the set of instructions and data directly executed by a computer's central processing unit or by a computing system, a human-understandable form, such as source code, which may be compiled in order to be executed by a computer's central processing unit or by a computing system, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a computing system.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A system for monitoring the wear rates of agricultural implements, the system comprising:
an agricultural implement having ground-engaging tools configured to work a field area;
at least one wear sensor configured to generate data indicative of wear of one or more of the ground-engaging tools; and
a computing system communicatively coupled to the at least one wear sensor, the computing system being configured to:
receive the data indicative of the wear of the one or more of the ground-engaging tools;
determine a first wear rate of the one or more of the ground-engaging tools based at least in part on the data indicative of the wear of the one or more of the ground-engaging tools;
compare the first wear rate to a threshold wear rate; and
perform a control action when a differential between the first wear rate and the threshold wear rate exceeds a wear rate differential threshold.

2. The system of claim 1, wherein the agricultural implement is a first agricultural implement, the ground-engaging tools are first ground-engaging tools, and the field area is a first field area,
the system further comprising a second agricultural implement having second ground-engaging tools configured to work a second field area, the second field area being the same as or different from the first field area,
wherein the at least one wear sensor is further configured to generate data indicative of wear of one or more of the second ground-engaging tools,
wherein the computing system is further configured to:
receive the data indicative of the wear of the one or more of the second ground-engaging tools; and
determine a second wear rate of the one or more of the second ground-engaging tools based at least in part on the data indicative of the wear of the one or more of the second ground-engaging tools,
wherein the threshold wear rate is the second wear rate.

3. The system of claim 2, wherein the control action comprises controlling an operation of a user interface to indicate that the one or more of the first ground-engaging tools are wearing faster than the one or more of the second ground-engaging tools.

4. The system of claim 2, wherein the control action comprises controlling an operation of the first agricultural implement to adjust at least one implement setting of the first agricultural implement to match at least one implement setting of the second agricultural implement.

5. The system of claim 2, wherein the at least one wear sensor comprises at least one first wear sensor provided in association with the first agricultural implement and configured to generate the data indicative of the wear of the one or more of the first ground-engaging tools and at least one second wear sensor provided in association with the second agricultural implement and configured to generate the data indicative of the wear of the one or more of the second ground-engaging tools.

6. The system of claim 2, wherein the at least one wear sensor is remote from the first and second agricultural implements.

7. The system of claim 1, wherein the threshold wear rate is a predetermined expected wear rate for the ground-engaging tools.

8. The system of claim 7, wherein the control action comprises controlling an operation of a user interface to indicate that the one or more of the ground-engaging tools are wearing faster than the predetermined expected wear rate.

9. The system of claim 7, wherein the control action comprises automatically controlling an operation of the agricultural implement to reduce at least one of a ground speed of the agricultural implement or a penetration depth of the ground-engaging tools.

10. The system of claim 1, wherein the data indicative of the wear of the one or more of the ground-engaging tools comprises vision-based data of the one or more of the ground-engaging tools.

11. A method for monitoring the wear rate of an agricultural implement having ground-engaging tools configured to work a field area, the method comprising:
receiving, with a computing system, data indicative of wear of one or more of the ground-engaging tools;
determining, with the computing system, a wear rate of the one or more of the ground-engaging tools based at least in part on the data indicative of the wear of the one or more of the ground-engaging tools;
comparing, with the computing system, the wear rate of the one or more of the ground-engaging tools to a threshold wear rate; and
performing, with the computing system, a control action when a differential between the wear rate of the one or more of the ground-engaging tools and the threshold wear rate exceeds a wear rate differential threshold.

12. The method of claim 11, wherein the agricultural implement is a first agricultural implement, the ground-engaging tools are first ground-engaging tools, and the field area is a first field area,
the method further comprising:
receiving, with the computing system, data indicative of wear of one or more second ground-engaging tools of a second agricultural implement configured to work a second field area, the second field area being the same as or different from the first field area; and
determining, with the computing system, a second wear rate of the one or more of the second ground-engaging tools based at least in part on the data indicative of the wear of the one or more of the second ground-engaging tools, wherein the threshold wear rate is the second wear rate.

13. The method of claim 12, wherein the control action comprises controlling an operation of a user interface to indicate that the one or more of the first ground-engaging tools are wearing faster than the one or more of the second ground-engaging tools.

14. The method of claim 12, wherein the control action comprises controlling an operation of the first agricultural implement to adjust at least one implement setting of the first agricultural implement to match at least one implement setting of the second agricultural implement.

15. The method of claim 12, wherein the data indicative of the wear of the one or more first ground-engaging tools is generated by at least one first wear sensor provided in association with the first agricultural implement and the data indicative of the wear of the one or more second ground-engaging tools is generated by at least one second wear sensor provided in association with the second agricultural implement.

16. The method of claim 12, wherein the data indicative of the wear of the one or more first ground-engaging tools and the data indicative of the wear of the one or more second ground-engaging tools is generated by at least one wear sensor, the at least one wear sensor being remote from the first and second agricultural implements.

17. The method of claim 11, wherein the threshold wear rate is a predetermined expected wear rate for the ground-engaging tools.

18. The method of claim 17, wherein the control action comprises controlling an operation of a user interface to indicate that the one or more of the ground-engaging tools are wearing faster than the predetermined expected wear rate.

19. The method of claim 17, wherein the control action comprises automatically controlling an operation of the agricultural implement to reduce at least one of a ground speed of the agricultural implement or a penetration depth of the ground-engaging tools.

20. The method of claim 11, wherein the data indicative of the wear of the one or more of the ground-engaging tools comprises vision-based data of the one or more of the ground-engaging tools.
